(19) United States
(12) Patent Application Publication
(10) Pub. No.: US 2026/0257342 A1
(43) Pub. Date: Sep. 3, 2026

(54) Force Sensing Module for Robotics with Integrated Orientation, Proximity Detection, and Human-in-the-Loop Control

(71) Applicant: Haply Robotics Inc., Montreal (CA)

(72) Inventors: Emy Normand, Montreal (CA); Michael Farquharson, Montreal (CA); Colin Gallacher, Montreal (CA); Antoine Weill-Duflos, Verdun (CA)

(21) Appl. No.: 19/462,222

(22) Filed: Jan. 28, 2026

Related U.S. Application Data
(60) Provisional application No. 63/750,454, filed on Jan. 28, 2025.

(51) Int. Cl. B25J 9/00; B25J 13/08

(52) U.S. Cl. CPC B25J 9/0081; B25J 13/085; B25J 13/086

(57) ABSTRACT

An effector assembly is disclosed herein. The effector assembly can include a sensor assembly. The sensor assembly can include a proximity sensor module configured to sense a proximity of object within a field of detection that extends around a first axis. The sensor assembly can also include a force sensor module positioned adjacent to the proximity sensor module along the first axis and configured to sense forces directed along the first axis and about the first axis. The effector assembly can also include an end effector module mounted to the force sensor module and centered on the first axis.

### CROSS-REFERENCE TO RELATED APPLICATIONS

This application claims the priority benefit of United States Provisional Patent Application Ser. No. 63/750,545 for a Force Sensing Module for Robotics with Integrated Orientation, Proximity Detection, and Human-in-the-Loop Control, filed on Jan. 28, 2025, which is hereby incorporated by reference in its entirety.

### BACKGROUND

### 1. Field

The present disclosure relates to sensor assemblies for monitoring the operation of robots, such as robotic arms.

### 2. Description of Related Prior Art

Traditional robotic force sensors, such as those from ATI Industrial Automation (https://www.ati-ia.com/index.aspx) and Bota Systems (https://www.botasys.com/), primarily rely on strain gauges to measure force and torque. These devices typically operate at speeds below 100 Hz, which is insufficient for real-time control in dynamic environments. Moreover, existing solutions lack the capability to integrate proximity, orientation, and human feedback into robotic systems. These limitations hinder robots' ability to perform complex tasks involving contact dynamics, obstacle negotiation, and intuitive adaptations akin to human dexterity. The need for real-time human guidance during robot training further complicates these challenges, as delays and system inflexibility reduce operational efficiency and accuracy.

The background description provided herein is for the purpose of generally presenting background context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

The subject matter of the present disclosure, in summary, is an effector assembly. The effector assembly can include a sensor assembly. The sensor assembly can include a proximity sensor module configured to sense a proximity of object within a field of detection that extends around a first axis. The sensor assembly can also include a force sensor module positioned adjacent to the proximity sensor module along the first axis and configured to sense forces directed along the first axis and about the first axis. The effector assembly can also include an end effector module mounted to the force sensor module and centered on the first axis.

### BRIEF DESCRIPTION OF THE DRAWINGS

The detailed description set forth below references the following drawings:

FIG. 1 is an isometric, or “perspective,” view of an embodiment of the present disclosure in an exploded relation to a robotic arm, an exemplary operational scenario contemplated by the present disclosure;

FIG. 2 is a first isometric view of the embodiment of the present disclosure shown in FIG. 1;

FIG. 3 is a second isometric view of the embodiment of the present disclosure shown in FIG. 1;

FIG. 4 is a third isometric view of the embodiment of the present disclosure shown in FIG. 1;

FIG. 5 is a fourth isometric view of the embodiment of the present disclosure shown in FIG. 1;

FIG. 6 is a fifth isometric view of the embodiment of the present disclosure shown in FIG. 1;

FIG. 7 is a side view of the embodiment of the present disclosure shown in FIG. 1;

FIG. 8 is a first isometric view of portions of a second embodiment of the present disclosure;

FIG. 9 is a second isometric view of the embodiment of the present disclosure shown in FIG. 7;

FIG. 10 is a third isometric view of the embodiment of the present disclosure shown in FIG. 7;

FIG. 11 is a fourth isometric view of the embodiment of the present disclosure shown in FIG. 7;

FIG. 12 is a schematic view of internal components of the embodiment of the present disclosure shown in FIG. 1; and

FIG. 13 is a schematic view of an operating environment in which the embodiment of the present disclosure shown in FIG. 1 can be utilized.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a force sensing module integrating a strain-gauge-based six-degree-of-freedom force sensor. Embodiments of the present disclosure, such as those set forth below, can also provide proximity sensors arranged in a ring configuration for surface and obstacle detection. Embodiments of the present disclosure, such as those set forth below, can also provide an inertial measurement unit (“IMU”) for measuring orientation and accelerations. Embodiments of the present disclosure, such as those set forth below, can also provide an onboard processing capabilities to reduce communication delays. Embodiments of the present disclosure, such as those set forth below, can also provide support for human-in-the-loop control using haptic devices.

Sensing modules according to the present disclosure can also provide real-time adjustments to force, position, and orientation based on sensory data. Sensing modules according to the present disclosure can also facilitate enhanced robot training by allowing human operators to guide and teach robots using haptic feedback and intuitive controls. Sensing modules according to the present disclosure can also permit dynamic adaptation of a robot during robotic operations to replicate human-like responsiveness, improving task precision and safety.

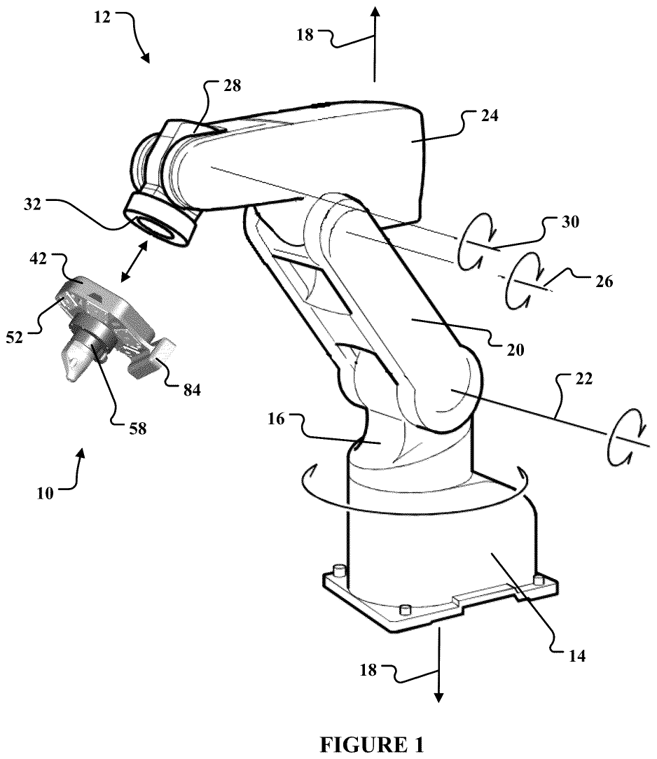

Referring now to FIG. 1, the present disclosure provides an effector assembly 10 configured to be mounted on a robot. FIG. 1 shows the exemplary effector assembly 10 mountable on a robot in the form of a robot arm 12. The exemplary robot arm 12 includes a base 14. The exemplary robot arm 12 also includes a first arm segment 16. The exemplary first arm segment 16 can include one or more internal motors and is rotatable relative to exemplary base 14 about an axis 18. The exemplary robot arm 12 also includes a second arm segment 20. The exemplary second arm segment 20 can include one or more internal motors and is rotatable relative to exemplary first arm segment 16 about an axis 22. The exemplary robot arm 12 also includes a third arm segment 24. The exemplary third arm segment 24 can include one or more internal motors and is rotatable relative to exemplary second arm segment 20 about an axis 26. The exemplary robot arm 12 also includes a fourth arm segment 28. The exemplary fourth arm segment 28 can include one or more internal motors and is rotatable relative to exemplary third arm segment 24 about an axis 30. It is noted that the robot arm 12 is exemplary and that embodiments of the effector assembly 10 can be engaged and interconnected with other forms of robots. The exemplary effector assembly 10 is interconnected to a distal end 32 of the fourth arm segment 32.

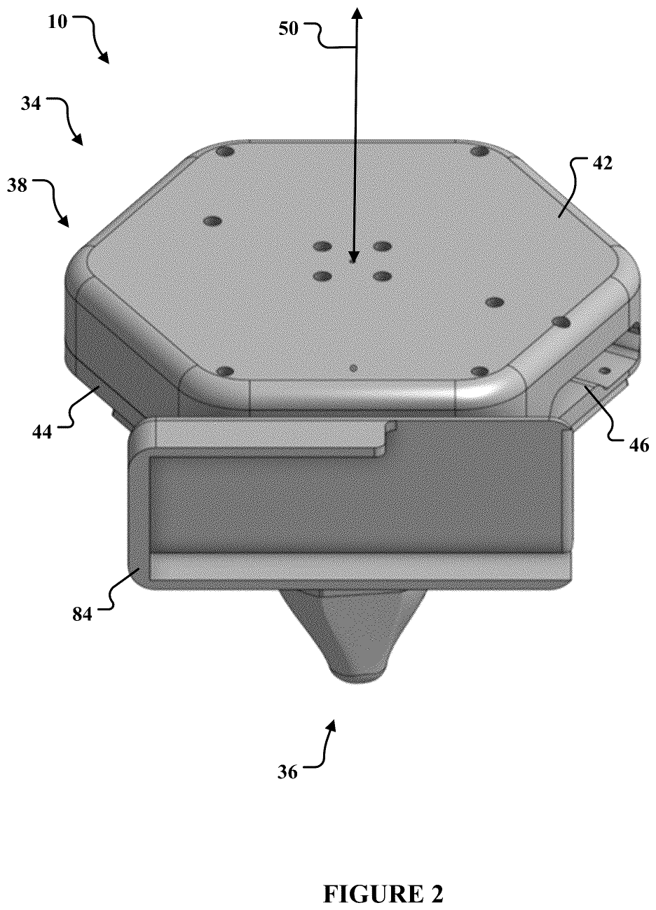

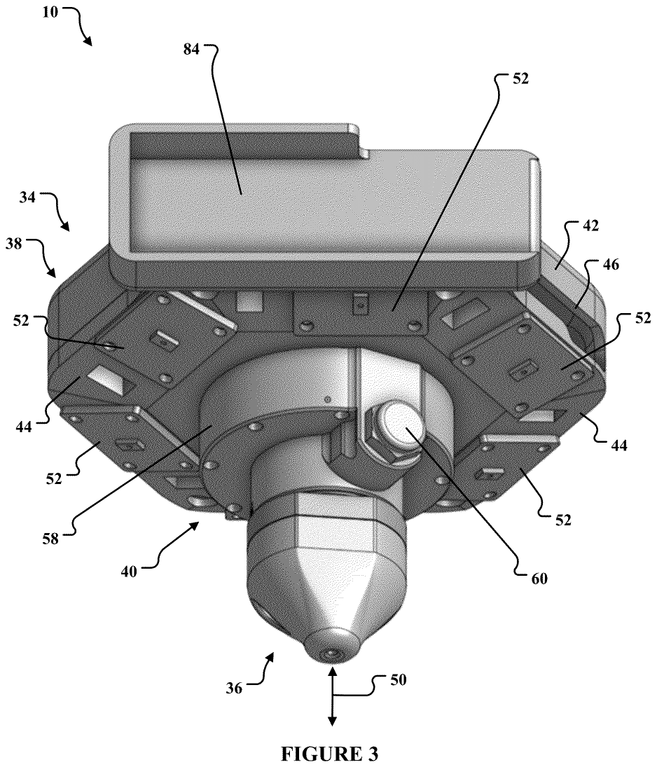

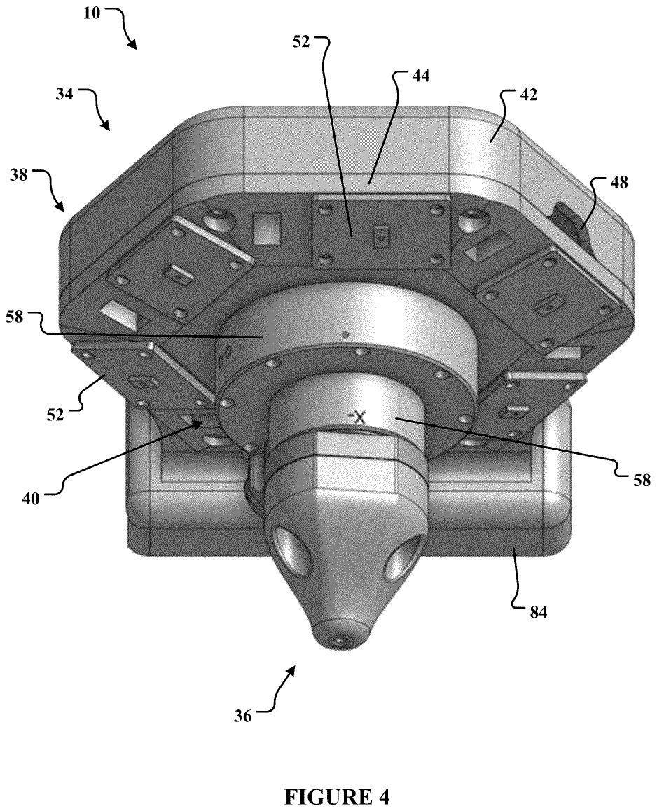

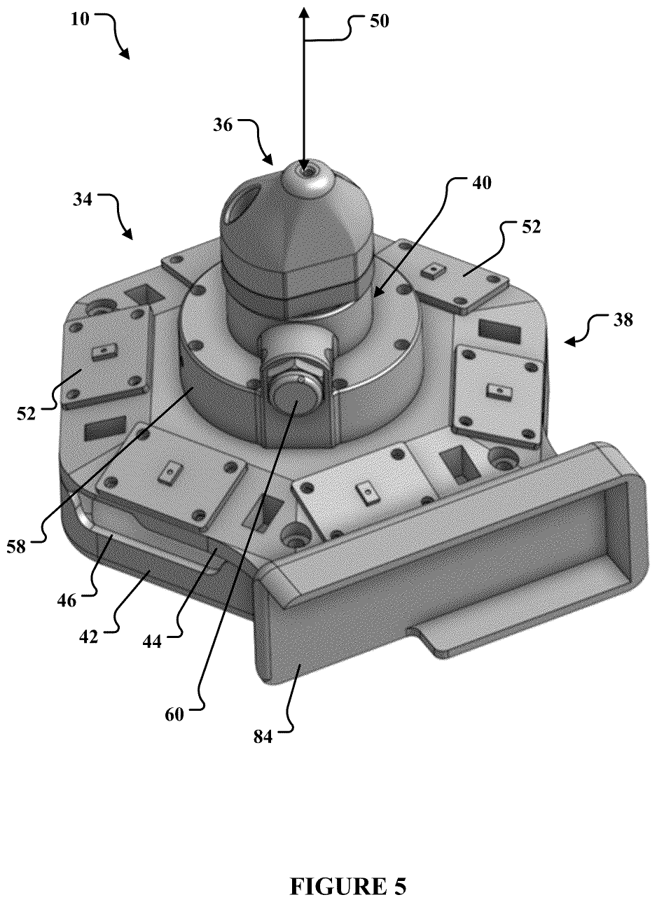

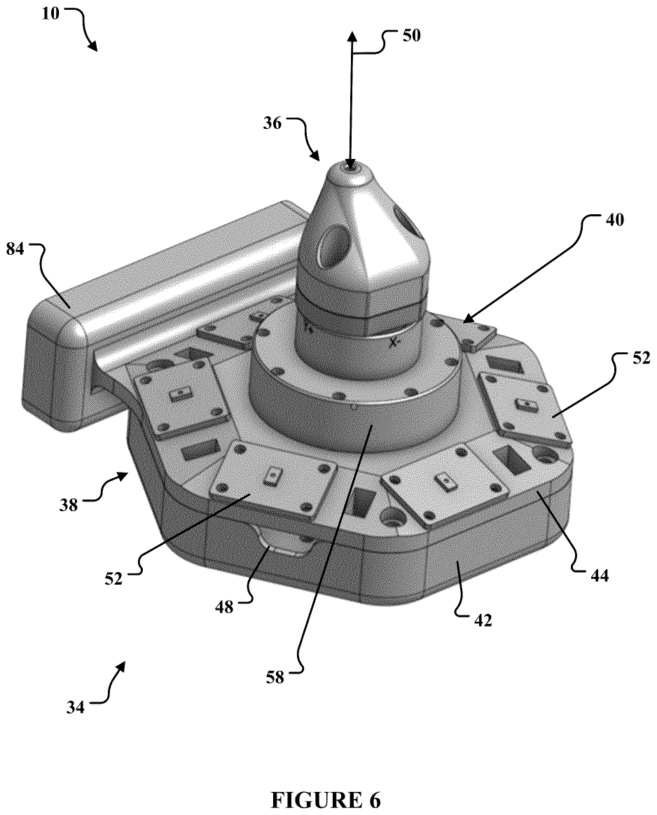

Referring now to FIGS. 2-7, an exemplary effector assembly 10 includes a sensor assembly 34 and an end effector module 36. The exemplary sensor assembly 34 includes a proximity sensor module 38 and a force sensor module 40.

The exemplary proximity sensor module 38 includes a container portion 42 and a lid portion 44. The container portion 42 can be connected to the distal end 32 of the robot arm 12. The container portion 42 and the lid portion 44 cooperate to define a housing having a cavity. Circuit components such circuit boards and wiring can be positioned with the cavity formed by the container portion 42 and the lid portion 44. Wiring can extend out of the cavity through one or more apertures defined between the container portion 42 and the lid portion 44, such as exemplary apertures 46, 48.

The exemplary proximity sensor module 38 is configured to sense a proximity of object within a field of detection that extends around a first axis 50. The exemplary proximity sensor module 38 includes a plurality (or an “array”) of proximity sensors (all referenced at 52) positioned at least partially around the first axis 50. At least most of the plurality of proximity sensors 52 can be positioned at the same location along the first axis 50 and in the exemplary embodiment all of the plurality of proximity sensors 52 are positioned at the same location along the first axis 50. At least most of the plurality of proximity sensors 52 can be spaced equidistantly from one another about the first axis 50 and in the exemplary embodiment all of the plurality of proximity sensors 52 are spaced equidistantly from one another about the first axis 50.

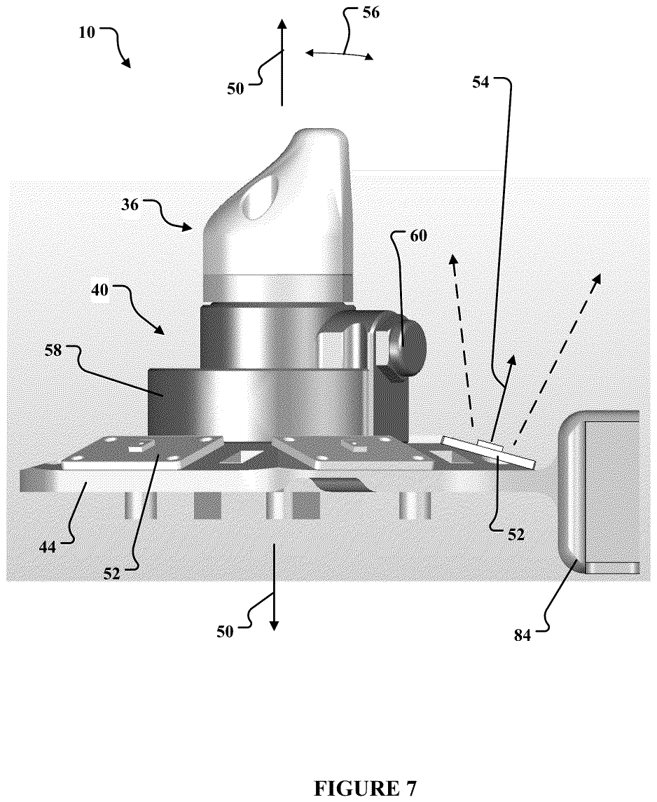

With particular reference to FIG. 7, each of the plurality of proximity sensors 52 defines a central proximity field axis 54. Each of the plurality of proximity sensors 52 defines an individual field of detection, represent in FIG. 7 by dash lines. In the exemplary embodiment, the central proximity field axis 54 of the proximity sensor 52 is transverse to the first axis 50. An angle (referenced at 56 in the exemplary embodiment) of forty-five degrees or less is defined between the central proximity field axis 54 of the proximity sensor 52 and the first axis 50. In one or more embodiments of the present disclosure, the angle that the proximity sensors 52 are tilted outward is approximately fifteen degrees. In the exemplary embodiment, the respective central proximity field axes 54 of all of the plurality of proximity sensors 52 are transverse to the first axis 50. As the sensors 52 encircle the axis 50, a field of detection, cumulatively defined by the sensors, extends three hundred and sixty degrees about the first axis 50.

Each of the sensors 52 can transmit signal data wirelessly or by wire. In one or more exemplary embodiments, wiring can extend between each of the sensors 52 and circuit board housed within the container portion 42 and the sensors 52 can be mounted on the lid portion 44. The circuit board (not shown) can include one or more processors and memory, for processing the signals received from the sensors according to logic stored in the memory. The circuit board can also include a transceiver for communicating data to another computing device wirelessly or by wire.

In one or more embodiments of the present disclosure, an inertial measurement unit (IMU) configured to sense the orientation of the assembly 10 and sense the acceleration of the assembly 10 can also be housed within the container portion 42 and can communicate sensed conditions to the processor(s) on the circuit board housed within the container portion 42. Thus, one or more embodiments of the present disclosure can provide onboard processing capabilities to reduce latency and enable real-time control of the robotic arm 12 and the assembly 12.

Referring again to FIGS. 2-7 , the exemplary force sensor module 40 is positioned adjacent to the exemplary proximity sensor module 38 along the first axis 50 and is fixed to the exemplary proximity sensor module 38. As best shown in FIG. 7, the exemplary force sensor module 40 is surrounded by the field of detection generated by the proximity sensors 52. The exemplary force sensor module 40 includes a housing 58 that houses a force sensor. The exemplary housing 58 defines an aperture to allow the passage of wiring. In the Figures, the aperture is closed by an exemplary releasable cap 60. The force sensor is configured to sense forces directed along the first axis 50 and about the first axis 50. These forces are the forces encountered by the end effector module 36. The force sensors can be a six-degree-of-freedom force sensor using strain-gauge technology.

The exemplary end effector module 36 is mounted to the force sensor module 40 and is centered on the first axis 50. The exemplary end effector module 36 is surrounded by the field of detection, as best shown in FIG. 7. The exemplary end effector module 36 is mounted to the distal end 32 of the robotic arm 12 and, during operation, interacts with a workpiece or a fixture or some other structure in a work environment. Tasks performed by an end effector module in various work environments can include, but are not limited to, manufacturing, assembly, and exploration. The exact structural nature of an end effector module used in an embodiment of the present disclosure depends on the nature of the work to be performed. Examples of end effector modules that can be applied in one or more embodiments of the present disclosure include grippers, vacuum cups, and magnetic tools to pick up, hold, and move objects. Other examples include tools for welding, painting, drilling, sanding, or dispensing materials such as adhesives.

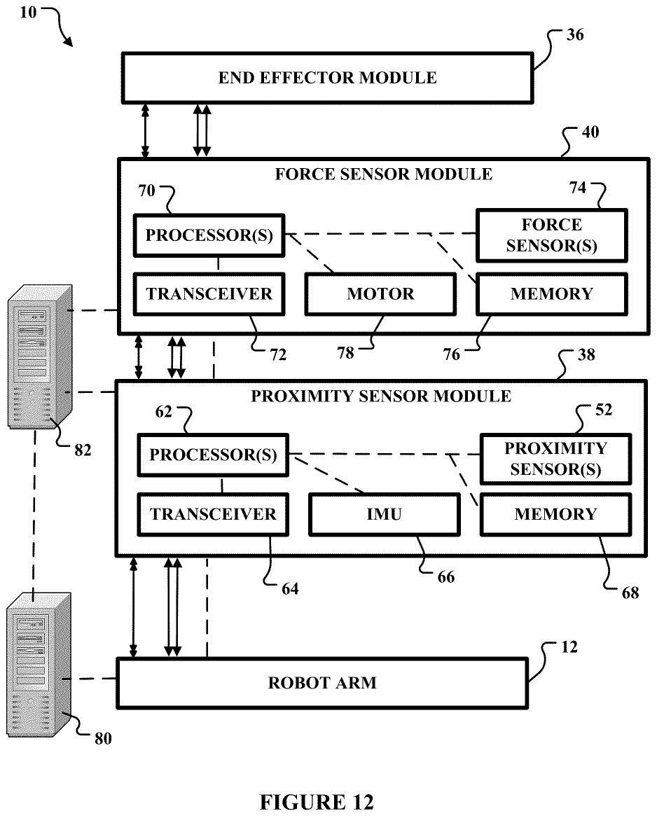

FIG. 12 is a schematic view of the embodiment of the present disclosure shown in FIG. 1. It is noted that embodiment is exemplary and is not limiting on the present disclosure. In FIG. 12, dash lines represent wireless or wired data communication; double-arrowhead lines represent power transmission, such as electrical power or pneumatic fluid; and double arrows represent the transmission of materials, such as materials output by the end effector 36. The exemplary proximity sensor module 38 includes one or more processors 62, a transceiver 64 for communication, an IMU 66, the proximity sensors 52, and memory 68. The exemplary proximity sensor module 38 can receive power from the robot arm 12 and communicate data (one-way or two-way) with the robot arm 12. Materials to be dispensed by the exemplary end effector 36, such as adhesive for example, can pass from the robot arm 12 and through the exemplary proximity sensor module 38.

The exemplary force sensor module 40 includes one or more processors 70, a transceiver 72 for communication, a force sensor 74, memory 76, and a motor 78. The exemplary force sensor module 40 can receive power from the exemplary proximity sensor module 38 and communicate data (one-way or two-way) with the exemplary proximity sensor module 38. Materials to be dispensed by the exemplary end effector 36 can pass from the exemplary proximity sensor module 38 and through the exemplary force sensor module 40. The motor 78 can provide power to the exemplary end effector module 36. It is noted that in one or more embodiments of the present disclosure, the force sensor module may not include a motor for the end effector module and power for the end effector module may be received from another source.

It is noted that the processor 62 can communicate the data generated by the sensors 52 and IMU 66, through the transceiver 64, through the robot arm 12 and subsequently used by a computing device 80 to control the movement of the robot arm 12. Alternatively, the processor 62 can communicate the data generated by the sensors 52 and IMU 66, through the transceiver 64, to a computing device 82 that is dedicated to processing data generated by the assembly 10. The computing device 82 can communicate the data to the computing device 80 for controlling the movement of the robot arm 12 based on the sensed data generated by the assembly 10. Similarly, the processor 70 can communicate data through the exemplary proximity sensor module 38, directly to the computing device 80, and/or directly to the computing device 82.

Referring again to FIGS. 2-7 , the exemplary assembly 10 also includes a mount 84 that is configured to releasably receive a relatively small display. The exemplary mount 84 is fixed to the exemplary proximity sensor module 38. The exemplary mount 84 is integrally formed with at least a portion of the exemplary proximity sensor module 38. “Integrally-formed” refers to the fact that in the exemplary embodiment the exemplary proximity sensor module 38 and the exemplary mount 84 are formed together rather than being formed separately and then subsequently joined. The term defines a structural feature since structures that are integrally-formed are structurally different than structures that are comprised of subcomponents formed separately and then subsequently joined. “Integral” means consisting or composed of parts that together constitute a whole and thus encompasses structures of more than one part wherein the parts are either integrally-formed or formed separately and then subsequently joined. As best shown in FIG. 7, the exemplary mount 84 is positioned outside of the field of detection.

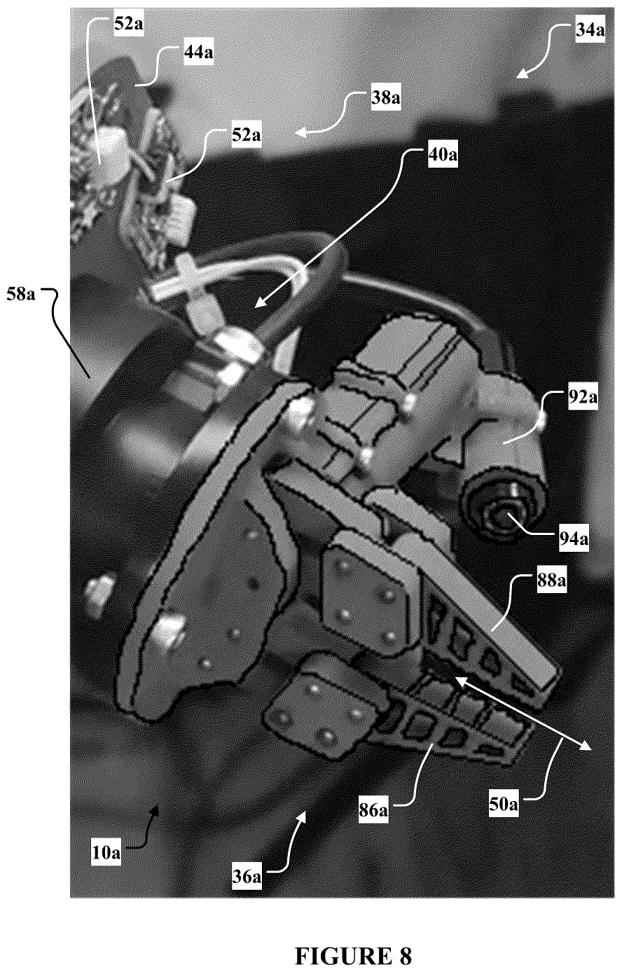

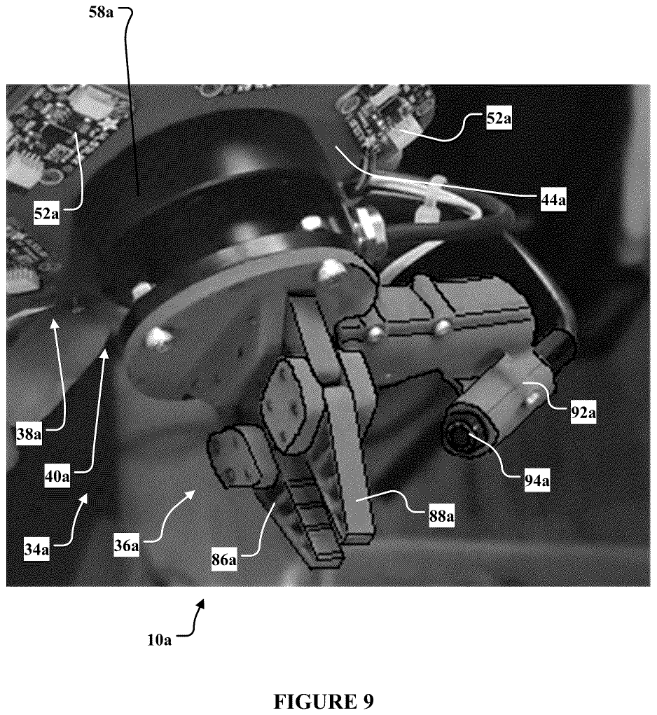

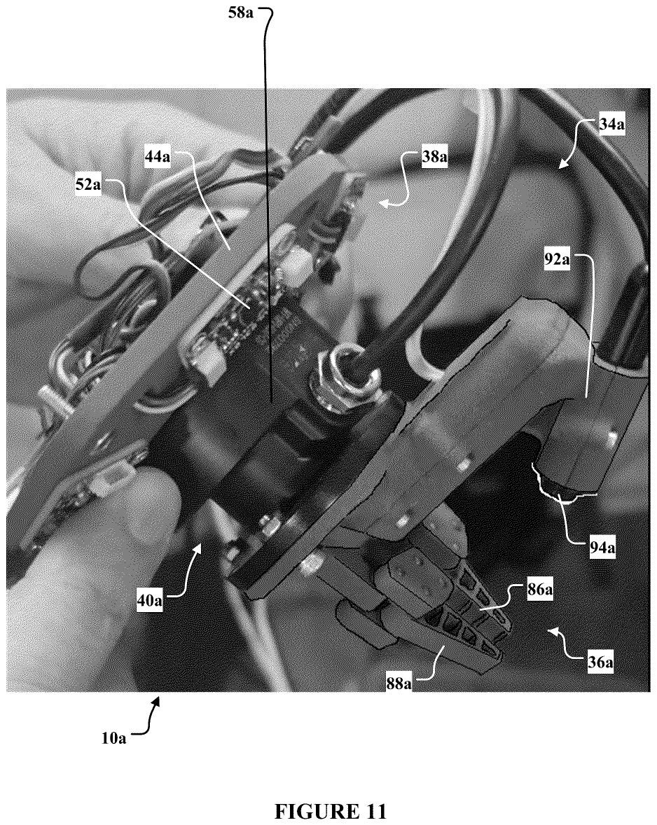

FIGS. 8-11 are partial views of a second embodiment of the present disclosure. An assembly 10a includes a sensor assembly 34a with a proximity sensor module 38a and a force sensor module 40a. The assembly 10a also includes an end effector module 36a. The exemplary proximity sensor module 38a includes a lid portion 44a and proximity sensors 52a arranged around a first axis 50a. The exemplary force sensor module 40a includes a housing 58a. The exemplary end effector module 36a includes a pair of jaws 86a, 88a that can move toward and away from one another to grasp a workpiece.

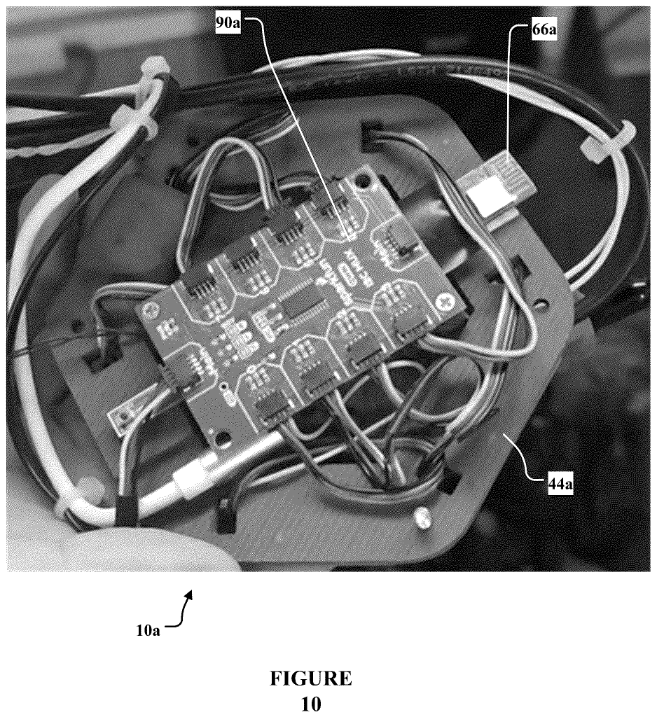

FIG. 10 shows an underside or interior side of the exemplary lid portion 44a. FIG. 10 also shows a circuit board 90a such as described above, as would be positioned in a housing defined by the proximity sensor module 38a. FIG. 10 also shows an IMU 66a.

The second embodiment of the assembly 10a also includes a mount 92a. The exemplary mount 92a is configured to receive a camera 94a. The exemplary mount 92a is fixed to the exemplary end effector module 36a. In other embodiments of the present disclosure, the mount 92a can be fixed to the proximity sensor module 38a or to the force sensor module 40a. The exemplary mount 92a can be positioned to be surrounded by the field of detection created by the proximity sensors 52a.

Referring again to FIGS. 1-7 and 12 , in operation, the processor 62, the processor 70, the processor(s) of the computing device 82, and/or the processor(s) of the computing device 80 can apply logic stored in memory to the data generated by the assembly 10 to control the movement of the robot arm 12 and also the movement of the end effector module 36. The logic can apply algorithms to the data to replicate human motion, such as light/gentle contact with structures rather than abrupt/high-force contact. By integrating data from the force sensor module, the IMU, and the proximity sensors, the assembly 10 dynamically adjusts robotic behavior during contact operations. The assembly 10 can compensate for delays in sensory data and human feedback, ensuring precise real-time control. The assembly 10 can predict and prepare for impending contact, enhancing stability and reducing the likelihood of damage to the robot arm 12 and/or the environment.

The assembly 10 can operate at data acquisition rates exceeding 1000 Hz, ensuring real-time processing, minimizing latency, and allowing for near-instantaneous adjustments. The exemplary proximity sensors 52 can utilize time-of-flight technology enabling obstacle detection and spatial awareness. The exemplary IMU 66 can provide continuous data on orientation and acceleration to allow for dynamic adjustments in robotic arm operations. By combining force, proximity, and orientation data, the assembly 10 can allow the robot arm 12 to make nuanced corrections akin to human reflexes, such as slowing down before contact or damping energy during impact. The assembly 10 also accounts for sudden changes in dynamics, such as those experienced during contact operations, preventing instabilities that commonly occur in traditional robotic systems.

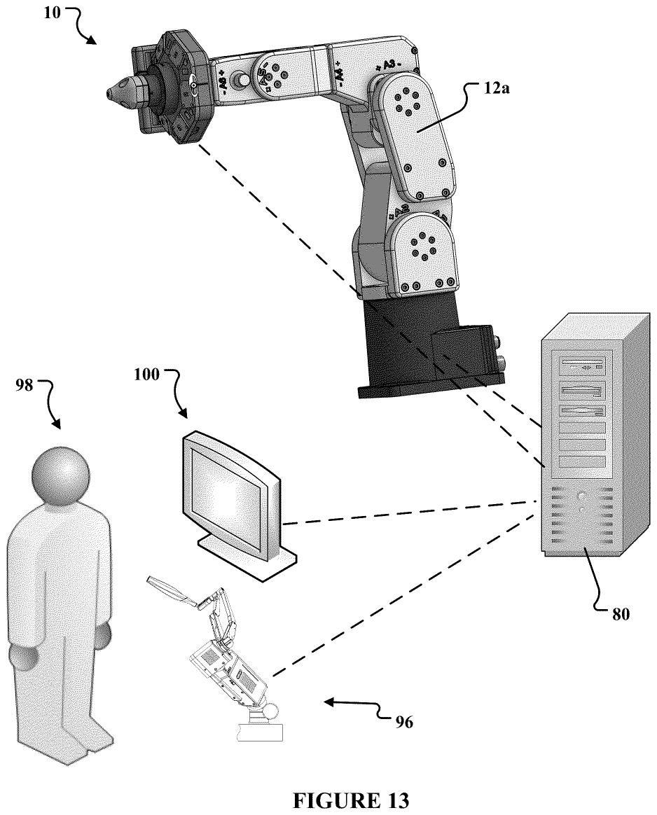

Referring now to FIG. 13, an assembly such as assembly 10 or 10a, or some other embodiment of the assembly, can be utilized in a “human-in-the-loop” control approaches. Further, such approaches can incorporate the use of haptic devices. Further, such approaches can be utilized to train a robot.

FIG. 13 shows the assembly 10 mounted on a robot arm 12a. Proximity data generated by the proximity sensors 52, motion data generated by the IMU 66, and force data generated by the force sensor 74 can be transmitted to the computing device 80. The computing device 80 can apply logic to this data and thereby generate controls for a haptic device 96. U.S. Pub. No. 2023/0315206 discloses a haptic device and is incorporated by reference for its disclosure regarding the haptic device.

A haptic device defines a human-machine interface and generates touch sensations (like force, vibration, or motion) to let the human users feel virtual objects via digital feedback. Haptic devices can include small motors to create vibrations and/or to apply forces and torques so that the user can feel resistance, mass, or friction arising in another setting, such as a robotic arm.

The computing device 80 can apply logic to the data received from the assembly 10 and thereby generate controls for a haptic device 96 to execute and produce haptic feedback to a human user 98 of the haptic device 96. In one or more other embodiments of the present disclosure, the haptic device 96 can directly receive data from the assembly 10, apply logic to the data, and thereby generate haptic feedback felt by the user 98 that corresponds to the conditions sensed by the assembly 10. In one or more embodiments, the user 98 can control movement of the robot arm 12a and/or the end effector module 36 through the haptic device 96 and the haptic feedback corresponds to the effects of the movement that has been directed or dictated by the user 98.

FIG. 13 also shows a display 100. In embodiments of the assembly including a camera, such as camera 94a, the video data can be presented on the display 100 to the user 98 as the user 98 controls the movement of the robot arm 12a and/or the end effector module 36. The user 98 can then control the movement of the robot arm 12a and/or the end effector module 36 based on part on the video data.

In one or more embodiments of the present disclosure, the control executed by the user 98 can be utilized as training for the robot arm 12a. The movement directed by the user 98 can be stored in memory and then applied by the processor(s) of the computing device 80 to control the movement of the robot arm 12a and the end effector module 36 without the user 98.

Thus, embodiments of the present disclosure support the integration of robot movement control with haptic devices, to enable human feedback and control during robot operations. Operators can directly guide robotic arms, transferring human intuition, precision, and adaptability to the robot during training or operational tasks. The haptic feedback system mirrors real-world sensations to the human operator, allowing intuitive corrections and teaching finer task nuances to the robot.

Embodiments of the present disclosure also enable robot training by capturing human-guided task paths and force interactions. Human operators, using haptic interfaces, can demonstrate complex paths or force-sensitive operations (e.g., sanding, grinding, or assembly). The robot thereby learns these tasks by mimicking human adjustments, benefiting from the operator's expertise while avoiding repetitive strain injuries common in manual tasks.

Humans and robots inherently differ in how they handle force interactions during contact. Humans rely on combined sensory inputs, including touch and vision, to manage force interactions. For instance, a human will slow down when approaching a surface and instinctively dampen excess energy during contact. The human musculoskeletal system is inherently back-drivable, allowing energy absorption and distribution across joints and muscles. This natural damping prevents damage during sudden impacts and enables fine adjustments in real-time. Embodiments of the present disclosure allow a trained robot to mimic human-like energy absorption by using advanced control algorithms that dynamically redistribute forces across the robotic arm. This reduces the risk of damage to both the robot and its environment. Unlike know systems that monitor robot movement, embodiments of the present disclosure integrate multiple sensory inputs to create a holistic understanding of the environment. This integration mirrors human reliance on touch and vision, leading to smoother and more natural interactions.

Embodiments of the present disclosure can be practiced in numerous industries, including those requiring precise and adaptable robotic operations, such as manufacturing, sanding, grinding, assembly tasks with complex geometries, surgical applications requiring delicate force control, and collaborative environments where robots and humans work side by side, demanding intuitive and safe robot behavior.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The expression “embodiment” herein does not relate to a specific set of features, but rather refers to preferred features described herein. The inventors also assert that any of the claims set forth after this detailed description can be combined with any other claim or claims regardless of whether or not there is a direct line of dependency, unless there is an express indication in this text or the drawings unambiguously indicating that such a combination is not possible. The order of the claims and the lines of dependency are irrelevant to the various ways that the features, elements, sub-elements, components, sub-components, etc. of the present disclosure can be combined and thus claimed. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure and it is noted that an “invention” is defined by the content of a patent claim and not by the content of descriptive text or drawings.

What is claimed is:

1. An assembly comprising:
a proximity sensor module configured to sense a proximity of object within a field of detection that extends around a first axis; and
a force sensor module positioned adjacent to said proximity sensor module along said first axis and configured to sense forces directed along said first axis and about said first axis.

2. The assembly of claim 1 wherein said proximity sensor module further comprises:
a plurality of proximity sensors positioned at least partially around said first axis.

3. The assembly of claim 2 wherein at least most of said plurality of proximity sensors are positioned at the same location along said first axis.

4. The assembly of claim 2 wherein at least most of said plurality of proximity sensors are spaced equidistantly from one another about said first axis.

5. The assembly of claim 2 wherein each of said plurality of proximity sensors defines a central proximity field axis and wherein the central proximity field axis of at least one of said plurality of proximity sensors is transverse to said first axis.

6. The assembly of claim 5 wherein an angle of forty-five degrees or less is defined between the central proximity field axis of the at least one of said plurality of proximity sensors and said first axis.

7. The assembly of claim 5 wherein the central proximity field axis of at least most of said plurality of proximity sensors is transverse to said first axis.

8. The assembly of claim 1 wherein said field of detection extends three hundred and sixty degrees about the first axis.

9. The assembly of claim 1 wherein said force sensor module is further defined as surrounded by said field of detection.

10. The assembly of claim 1 wherein said force sensor module is further defined as fixed to said proximity sensor module.

11. The assembly of claim 1 further comprising:
a mount configured to receive a display and fixed to said proximity sensor module.

12. The assembly of claim 11 wherein said mount is further defined as outside of said field of detection.

13. The assembly of claim 11 wherein said mount is further defined as integrally formed with at least a portion of said proximity sensor module.

14. The assembly of claim 1 further comprising:
an end effector module mounted to said force sensor module and centered on said first axis.

15. The assembly of claim 14 wherein said end effector module is further defined as surrounded by said field of detection.

16. The assembly of claim 14 further comprising:
a mount configured to receive a camera and fixed to one of said end effector module and said proximity sensor module.

17. The assembly of claim 14 wherein said mount is further defined as surrounded by said field of detection.

18. A method of operating the assembly of claim 14 comprising:
mounting the assembly on a robot;
transmitting, with the proximity sensor module, proximity data to a haptic device;
transmitting, with the force sensor module, force data to the haptic device; and
controlling the movement of the robot with the haptic device.

19. The method of claim 18 further comprising:
controlling the movement of the end effector module with the haptic device.

20. The method of claim 19 further comprising:
storing, in memory, the movement of the robot during said controlling the movement of the robot with the haptic device; and
controlling, after said storing, the movement of the robot based on the movement stored in memory during said storing.
